(19) United States
(12) Patent Application Publication
(10) Pub. No.: US 2005/0147875 A1
(43) Pub. Date: Jul. 7, 2005

(54) Battery holder

(75) Inventors: Shih-Heng Chang, Hsinchu (TW); Kuang-Hsiang Chang, Hsinchu (TW)

Correspondence Address: BIRCH STEWART KOLASCH & BIRCH, PO BOX 747, FALLS CHURCH, VA, 22040-0747, US

(73) Assignee: Microtek International Inc., Hsinchu (TW)

(21) Appl. No.: 11/011,041

(22) Filed: Dec. 15, 2004

(30) Foreign Application Priority Data
Jan. 6, 2004 (TW) 093100298

(51) Int. Cl. H01M 2/10

(52) U.S. Cl. 429/100; 429/9; 429/97

(57) ABSTRACT

A battery holder includes a casing, a set of engaging structures, and a baffle plate. The casing has a first surface and an opposed second surface flatter than the first one, and the second surface is formed with an opening at its central location and two apertures at its end. The set of engaging structures is formed on the second surface of the casing, and the baffle plate is pivotally supported on the engaging structures. The baffle plate is formed with a central projection at its central location and two end projections at its end. While the baffle plate is mounted on the second surface of the casing, the central projection is inserted into the casing through the opening and the end projections are inserted into the casing through the apertures.

This application claims the benefit of the filing date of Taiwan Application Ser. No. 093100298, filed on Jan. 6, 2004, the content of which is incorporated herein by reference.

### BACKGROUND

The invention relates to a battery holder and, more particularly, to a battery holder applicable for both a CRV3 battery and two AA batteries.

FIG. 1 shows a schematic view illustrating a typical CRV3 battery, which is often used at power digital camera and has a voltage of 3 volt. Referring to FIG. 1, though the CRV3 battery looks as if two AA batteries were situated side by side, actually the length of a CRV3 battery is somewhat longer than that of an AA battery. Hence, if two AA batteries are received side by side in the battery holder applicable for a CRV3 battery, the shorter length of the AA batteries may result in a poor electrical connection or even a disconnection.

To solve this problem, according to the conventional method, a movable baffle plate is provided in the bottom of the battery holder to manually adjust its housing length, such that different types of the batteries having different lengths may be received in the same battery holder.

However, not only is the manual operation fairly inconvenient, but also a poor electrical connection or even a disconnection may exist when one forgets to manually adjust the position of the baffle plate.

### BRIEF SUMMARY OF THE INVENTION

In view of the above-mentioned problems, an object of the invention is to provide a battery holder applicable for both a CRV3 battery and two AA batteries.

To achieve the above-mentioned object, the battery holder includes a casing, a set of engaging structures, and a baffle plate. The casing has a first surface and an opposed second surface flatter than the first one, and the second surface is formed with an opening at its central location and two apertures at its end. The set of engaging structures is formed on the second surface of the casing, and the baffle plate is pivotally supported on the engaging structures. The baffle plate is formed with a central projection at its central location and two end projections at its end. While the baffle plate is mounted on the second surface of the casing, the central projection is inserted into the casing through the opening and the end projections are inserted into the casing through the apertures.

Through the design of the invention, when the CRV3 battery is placed in the battery holder, the CRV3 battery pushes the central projection up to allow a rotation of the baffle plate with respect to the engaging structure such that the end projections are moved upward to be away from the casing and do not obstruct the reception of the CRV3 battery. On the other hand, when the AA batteries are situated side by side in the battery holder, they do not push the central projection up such that they are pressed against the end projections and tightly held in place.

### BRIEF DESCRIPTION OF THE DRAWINGS

FIG. 1 shows a schematic view illustrating a typical CRV3 battery.

FIG. 2 shows a schematic view illustrating a battery holder according to an embodiment of the invention.

FIG. 3 shows the schematic structure of a baffle plate facing the flat surface of the casing.

FIG. 4A shows a front view of the battery holder under the condition that a CRV3 battery is housed in it.

FIG. 4B shows a side view of the battery holder under the condition that a CRV3 battery is housed in it.

FIG. 5A shows a front view of the battery holder under the condition that two AA batteries are housed in it.

FIG. 5B shows a side view of the battery holder under the condition that two AA batteries are housed in it.

### DETAILED DESCRIPTION OF THE INVENTION

The battery holder of the invention will be described with reference to the accompanying drawings.

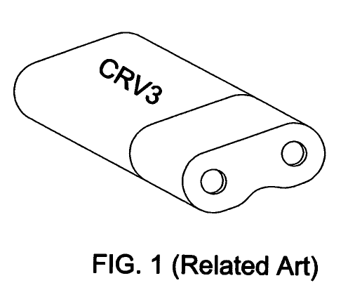

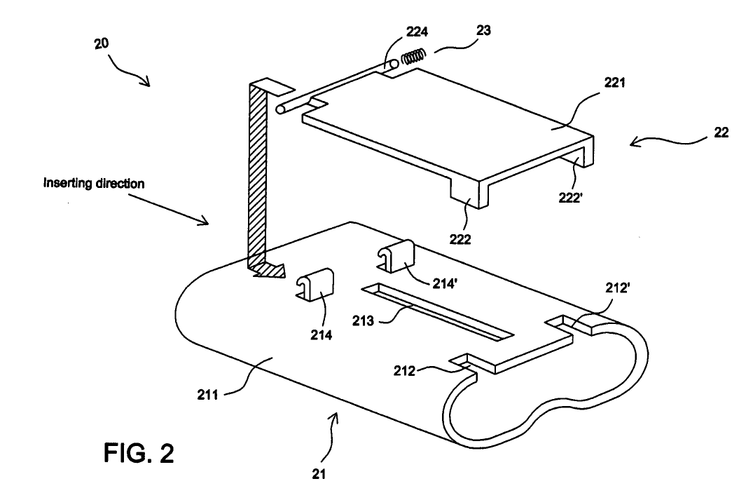

Referring to FIG. 2, there is shown a battery holder 20 which includes a retaining body 21 and a baffle plate 22. The retaining body 21 includes a casing 211 that has the same or substantially the same shape as a CRV3 battery for housing. The casing 211 is designed to have two opposite surfaces where one surface is flatter than the other and defined as the flat surface, similar to the two opposite surfaces of a typical CRV3 battery shown in FIG. 1.

The flat surface of the casing 211 is formed with an opening 213 approximately at its central location and two apertures 212 and 212′ at its end. Preferably, the opening 213 may be in a rectangular shape. Further, a set of engaging structures 214 and 214′ is formed on the flat surface of the casing 211 opposite to the apertures 212 and 212′, and the baffle plate 22 is pivotally supported on the set of engaging structures 214 and 214′.

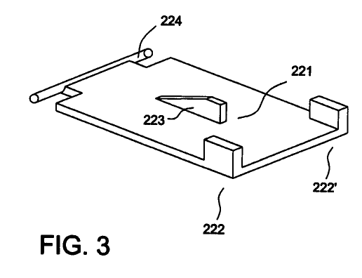

FIG. 3 shows the schematic structure of the baffle plate 22 facing the flat surface of the casing 211.

Referring to FIG. 3, the baffle plate 22 includes a main body 221 and a lever 224. On the baffle plate 22, a central projection 223 is formed approximately at its central location and two end projections 222 and 222′ are formed at its end. Further, a spring 23 is carried on the lever 224.

As the baffle plate 22 is mounted on the flat surface of the casing 211 and no batteries are received therein, the baffle plate 22 is constrained by the elastic force of the spring 23 such that the flat surface of the casing 211 is overlaid with the baffle plate 22. In that case, the central projection 223 is inserted into the casing 211 through the rectangular opening 213, and the end projections 222 and 222′ are inserted into the casing 211 through the end opening 212 and 212′.

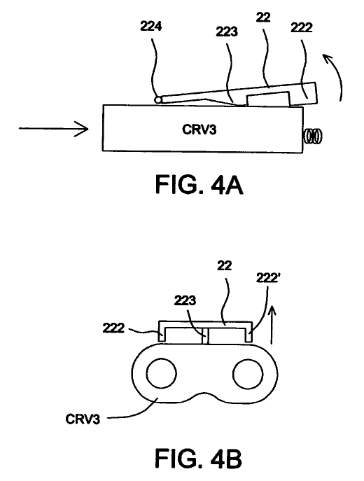

FIGS. 4A and 4B show how the battery holder 20 according to the invention houses a CRV3 battery. Unlike two AA batteries situated side by side having a gap therebetween, a typical CRV3 battery is known for having a shape similar to a rectangular solid without a gap formed in its central portion. Hence, referring to FIGS. 4A and 4B, when a CRV3 battery is placed in the battery holder 20, the flat surface of the CRV3 battery pushes the central projection 223 of the baffle plate 22 up to allow a rotation of the baffle plate 22 with respect to the engaging structures 214 and 214′ such that the end projections 222 and 222′ are moved upward to be away from the casing 221. Thereby, one end of the CRV3 battery may go deep in the casing 221 and exactly touch the bottom of the battery holder 20.

Preferably, the central projection 223 may be wedge-shaped having an inclined surface to be in contact with the CRV3 battery.

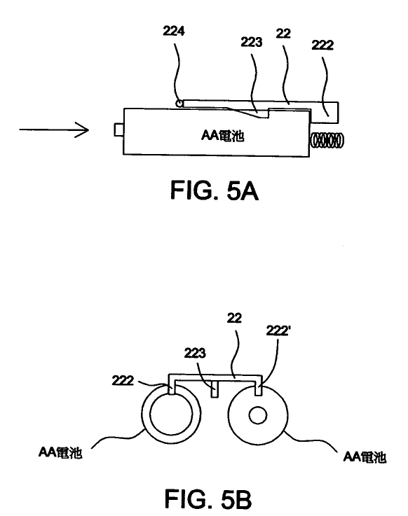

On the other hand, FIGS. 5A and 5B show how the battery holder according to the invention houses two AA batteries. Since the AA battery is cylindrically shaped, two AA batteries positioned side by side form a gap therebetween. Hence, when two AA batteries are placed in the battery holder 20, they do not push the central projection 223 up such that the two AA batteries are pressed against the end projections 222 and 222′ inserted in the casing 221 and are tightly held in place. Therefore, even an AA battery is shorter than a CRV3 battery in length; this never results in a poor electrical connection or a disconnection according to the invention.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. For example, the spring 23 may be arranged on the baffle plate 22 neighboring the end projections 222 and 222′ instead of being carried on the lever 224. Therefore, the scope of the appended claims should be accorded the broadest interpretation so as to encompass all such modifications and similar arrangements.

1. A battery holder applicable for both a CRV3 battery and two AA batteries, comprising:
a casing for housing a CRV3 battery or two AA batteries, the casing having a first surface and an opposed second surface flatter than the first one, the second surface being formed with an opening approximately at its central location and two apertures at its end;
a set of engaging structures formed on the second surface of the casing; and
a baffle plate pivotally supported on the set of engaging structures, the baffle plate being formed with a central projection approximately at its central location and two end projections at its end, and the central projection being inserted into the casing through the opening and the end projections being inserted into the casing through the apertures while the baffle plate being mounted on the second surface of the casing;
whereby, for the insertion of the CRV3 battery, the CRV3 battery pushes the central projection up to allow a rotation of the baffle plate such that the end projections are moved upward to be away from the casing and do not obstruct the reception of the CRV3 battery, and, for the insertion of the AA batteries, the AA batteries do not push the central projection up such that the AA batteries are pressed against the end projections and are tightly held in place.

2. The battery holder as claimed in claim 1, wherein the shape of the casing conforms to that of the CRV3 battery.

3. The battery holder as claimed in claim 1, wherein the opening is in a rectangular shape.

4. The battery holder as claimed in claim 1, wherein the baffle plate has a lever through which the baffle plate is pivotally supported on the set of engaging structures.

5. The battery holder as claimed in claim 4, further comprising a spring carried on the lever to restore the baffle plate to a position where the second surface of the casing is overlaid with the baffle plate as no external force is exerted on the baffle plate.

6. The battery holder as claimed in claim 1, wherein the central projection is wedge-shaped having an inclined surface.
